(19) United States
(12) Patent Application Publication
(10) Pub. No.: US 2006/0218425 A1
(43) Pub. Date: Sep. 28, 2006

(54) Integrated microcontroller and memory with secure interface between system program and user operating system and application

(76) Inventors: Zhimin Ding, Sunnyvale, CA (US); Shane Hollmer, San Jose, CA (US); Philip Barnett, Clanfield (GB)

Correspondence Address: DLA PIPER RUDNICK GRAY CARY US, LLP, 2000 UNIVERSITY AVENUE, E. PALO ALTO, CA, 94303-2248, US

(21) Appl. No.: 11/345,074

(22) Filed: Jan. 31, 2006

Related U.S. Application Data
(60) Provisional application No. 60/661,682, filed on Feb. 25, 2005.

(51) Int. Cl. G06F 1/00

(52) U.S. Cl. 713/323

(57) ABSTRACT

An integrated circuit device has a processing unit, a memory management unit, and a memory. The memory management unit is interposed between the memory and the processing unit for controlling access to the memory by the processing unit in one of three modes. In a first mode, called the system mode, the processing unit can access a system program stored in the memory for controlling the resources of the integrated circuit device. In a second mode, called the kernel mode, the processing unit can access an operating system program stored in the memory for controlling the of the integrated circuit device, limited by the system program. Finally in a third mode, called the user mode, the processing unit can access an application program stored in the memory for controlling the resources of the integrated circuit device, limited by the operating system program. In another aspect of the invention, when the processing unit accesses either the operating system program or the application program (herein: “non-system program”), the execution of the non-system program can cause a system interrupt causing program execution to revert to the system mode, but to a specified entry address of the system program, wherein after processing the system interrupt, operation returns to the non-system program in either the kernel mode or the user mode.

The present application claims the priority of Provisional application 60/661,682 filed on Feb. 25, 2005, whose disclosure is incorporated herein by reference in its entirety.

### TECHNICAL FIELD OF THE INVENTION

The present invention relates to an apparatus for securely interfacing a system program from a user operating system program and application program in an integrated microcontroller and memory device.

### BACKGROUND IF THE INVENTION

A secure system-on-chip (SOC), such as a smart-card, is often provided with some amount of built-in system software, or firmware. This built-in system software is usually granted special access to low level digital and analog circuits, or hardware assets. Examples of these hardware resources are, security sensors, crypto-coprocessors, secure memory management, and protection circuits. Together, the system software and hardware assets it accesses perform functions that are vital to the security and integrity of the system.

System software functions are normally executed under 3 conditions:

1. During bootloading process.

2. Executed as handlers of interrupts.

3. Called by the user operating system via a well-defined application program interface (API).

System software can also include certain sensitive data, such as encryption keys.

For security and system integrity reasons, it is desired to protect the system software so that,

1. User Operating System (OS) program and application programs cannot read or dump the system memory content.

2. User OS and application programs cannot invoke or cause the system software to execute, except through the application program interface (API) defined by the system designer.

3. User OS and application programs cannot be granted to special hardware access condition that are only granted to the system software.

Traditional microcontrollers, or CPUs, have one homogeneous memory space (some times split between code and data) for the CPU to access unconditionally. The system program, which is usually installed by the manufacturer of the CPU, should not be placed as a part of the homogeneous main program memory. This is because with most CPUs, instructions are available to read the content of the main memory. Additionally, the user application programs can jump into any location of the system software if placed in main memory, and can cause the system software to be executed partially, causing unexpected effects. Users with ill-intent can also replace the system software with malicious code segments (Trojan horse), which can access the low level hardware in a way that can compromise system integrity and security. Finally, if the system program is placed in the main memory where user can have read access, sensitive data, such encryption key may be read out, thereby destroying the security feature of the CPU.

### SUMMARY OF THE INVENTION

The present invention relates to an integrated circuit device which comprises a processing unit, a memory management unit, and a memory. The memory management unit is interposed between the memory and the processing unit for controlling access to the memory by the processing unit in one of three modes. In a first mode, called the system mode, the processing unit can access a system program stored in the memory for controlling the resources of the integrated circuit device. In a second mode, called the kernel mode, the processing unit can access an operating system program stored in the memory for controlling the of the integrated circuit device, limited by the system program. Finally in a third mode, called the user mode, the processing unit can access an application program stored in the memory for controlling the resources of the integrated circuit device, limited by the operating system program.

In another aspect of the present invention, an integrated circuit device comprises a processing unit, a memory management unit, and a memory. The memory management unit is interposed between the memory and the processing unit for controlling access to the memory by the processing unit in one of two modes. In a system mode, the processing unit can access a system program from the memory for controlling resources of the integrated circuit device. In a non-system mode, the processing unit can access a non-system program, wherein execution of the non-system program can cause a system interrupt causing program execution to revert to the system mode, but to a specified entry address of the system program, wherein after processing the system interrupt, operation returns to the non-system program in the non-system mode.

### BRIEF DESCRIPTION OF THE DRAWINGS

FIG. 1 is a table showing the different settings of the mode bits and the modes of operation of the present invention.

FIG. 2 is a memory mapping diagram showing the system program accessing code and data in separate memory maps during the system mode of operation.

FIG. 3 is a memory mapping diagram showing the user operating system program accessing code and data in a unified memory map during the kernel mode of operation.

FIG. 4 is a memory mapping diagram showing the program in the kernel mode invoking an interrupt to jump into the memory map of the system mode for execution by the system mode program, and the return of operation to the kernel mode after the execution by the system mode program.

FIG. 5 is a memory mapping diagram showing the program in the kernel mode invoking an interrupt to jump into the memory map of the system mode for execution by the system mode program, and system program operating in the system mode, not returning the operation to the kernel mode.

FIG. 6 is an example of a hardware implementation of the integrated circuit device of the present invention.

FIG. 7 is a graph of the relationship between hardware, the system program and the user operating system program (OS) and the user application program.

FIG. 8 is a graph showing mode switching mechanism.

FIG. 9 is a graph showing Physical to logical memory mapping.

FIG. 10 is a graph showing the physical memory space of the best mode of the device of the present invention.

FIG. 11 is a graph of the system mode memory map.

FIG. 12: is a memory map after initial system program load, configured as a Von Neumann architecture.

FIG. 13: is a memory map after initial system program load, configured as a Harvard architecture.

FIG. 14 is a graph of an alternative memory map to enable banking.

FIG. 15 is a graph showing the relationship between the logical address and the physical address

FIG. 16 shows the details of the interface between the CPU and the MMU.

FIG. 17 shows one embodiment of the detail block level diagram of the MMU

FIG. 18 shows the memory map of virgin state 0.

FIG. 19 shows the memory map of virgin state 1.

### DESCRIPTION OF THE INVENTION

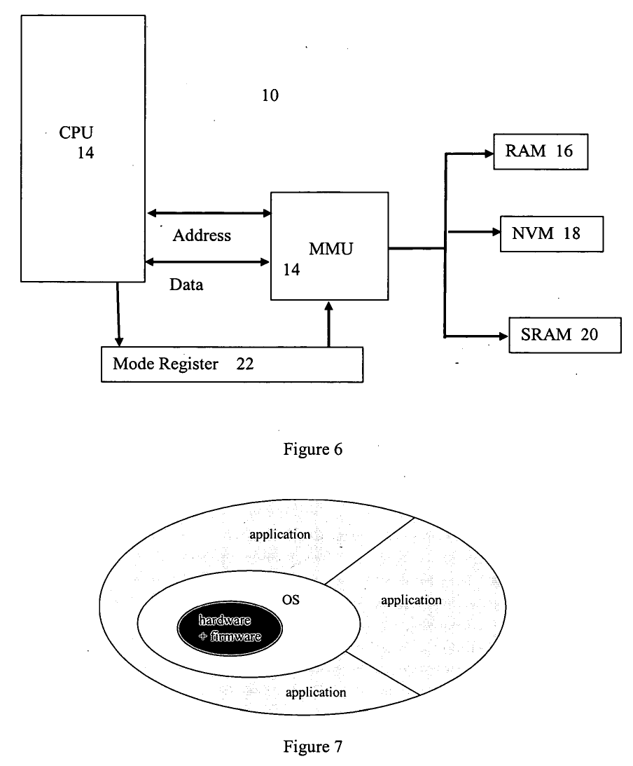

Referring to FIG. 6 there is shown a block level diagram of an integrated circuit device 10 of the present invention. The device 10 comprises a microcontroller (“CPU”) 12, a memory management unit (“MMU”) 14, and a plurality of different types of memory (16, 18 and 20) (although the present invention may be practiced by just one type of memory). The device 10 also comprises a mode register 22. The CPU 12, the MMU 14, the various memories (16, 18 and 20), and the mode register are all integrated in a single circuit package module (“Chip”). The device 10 may be packaged in a single circuit package module with a single silicon die having the components of CPU 12, MMU 14, various memories, 16, 18 and 20 and the mode register 22. It is also within the scope of the present invention that, the device 10 may also be packaged in a single circuit package module with a plurality of dies (the so called Multi-Chip Package (MCP)).

The CPU 12 is connected to the MMU 14 by an address bus and by a data bus. The MMU 14 in turn is connected to each of the memories 16, 18 and 20 by an address bus and a data bus. Thus, the MMU 14 is interposed between the CPU 12 and the memories 16, 18 and 20, and controls the access of the memories 16, 18 and 20 by the CPU 12. As shown in FIG. 6, the device 10 comprises different types of memories, RAM 16, (such as DRAM which is volatile) NVM 18 (or non-volatile memory 18), with its associated write (or program) and erase circuits to control the operation of the NVM 18, and SRAM 20 (which is also volatile but faster in operation than RAM 16). The device 10 also comprises a Mode Register 22. The CPU 12 can access the Mode Register 22, as well as the MMU 14 can access the Mode Register 22.

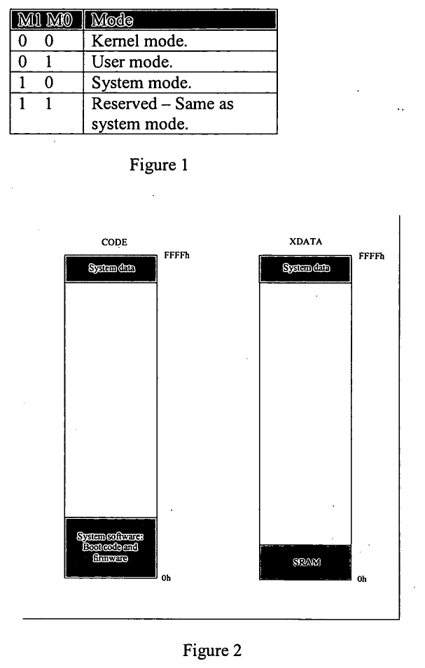

The CPU 12 in the device 10 has more than one mode of operation. The CPU 12 can execute in a: system mode, a kernel mode and a user mode. The particular mode of operation by the CPU 12 is determined by a couple of register bits called the mode bits set in the Mode Register 22. FIG. 1 is an example of the setting of two mode bits to control the mode of operation of the CPU 12.

In a system mode of operation, the manufacturer installed firmware or program (also called “system software”) is executed. In a Kernel mode of operation, the operating system program installed by the user (also called “kernel software”) is executed. Finally, in a user mode of operation the application program(s) installed by the user is executed.

The present invention focuses on the interface between the system software and the kernel software, which is usually the user's operating system. Interfaces between other modes, such as between the user mode and the kernel mode, can be treated in a same way.

Further, the right of the CPU 12 to access hardware resources of the device 10 is determined by the mode of operation of the CPU 12. Resources of the device can include security sensors, cryptographic coprocessor interface registers, write and erase circuits to NVM 18, analog circuits, and timers. In a system mode, the CPU 12 can access all the hardware resources of the device 10. This can be accomplished by hardware, such as by the output of the Mode Register 22 bits (when the System Mode bits are set M1=1 and M2=0, see FIG. 1) to control access to the hardware resources. Alternatively, the system software can check the System mode bits before access to the hardware resources is granted.

In the kernel mode of operation, the CPU 12 can access most of the hardware resources such as timer, non-volatile memory write and erase controllers etc. However, those hardware resources that are most critical to the system integrity and security are not accessible in the Kernel mode. The limitation of access during the kernel mode is enforced by hardware design. In the kernel mode, the CPU 12 can access services limited by the system software, which in turn limits access to all critical hardware resources. In such a way, the amount of access privilege to various hardware resources by the user operating system (or kernel software) running in the kernel mode is defined by the system software.

Finally, in the user mode, the CPU 12 can only access the common CPU registers, and hardware resources limited by the kernel software. The limitation of access to the user operating system resources by the user program operating in the user mode, is defined by the user operating system running in kernel mode, similar to the manner in which access to the user system program in the kernel mode may be limited by the system program.

All of the limitation of access to the hardware resources by the system program, the kernel program and the user program is controlled by the MMU 14. The MMU 14 limits access to the various programs stored in the memories 16, 18 and 20 by the CPU 12. Moreover, the memory map for the CPU 12 is different in each operating mode. The MMU 14 controls the mapping from physical memory to the logic memory space of the CPU 12 for each mode of operation. It is designed such that the MMU 14 creates different memory maps in different operating mode. The MMU 14 mapping is controlled by the system software. Thus, similar to the system program controlling and limiting the access to hardware resources by the kernel program in the kernel mode, the system program also limits the kernel program's access to the memory mapping.

For example, in the system mode of operation, the memory map that the CPU 12 can access looks like that shown in FIG. 2. In this mode, the CPU 12 can access the code in one memory map, and the data in a separate memory map.

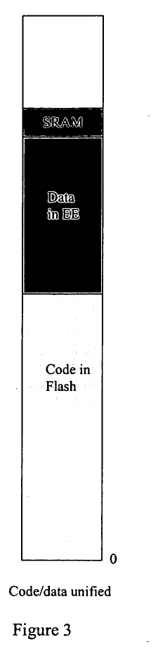

However, in the kernel mode of operation, the memory map that the CPU 12 can access changes to a different one, such as that shown in FIG. 3. In this Kernel mode, the CPU 12 can access the code and data in a single unified memory map. In executing the program in the kernel mode, the kernel program cannot “see” the memory mapped to the system mode. By doing this, the kernel program executing in the kernel mode cannot access the program and data in the system memory arbitrarily. The program executing in the kernel mode can only access the hardware resources or services provided by the system program through a strictly defined protocol as explained below.

In order for a kernel program in the kernel mode to request a system service or hardware resource, the kernel program has to evoke a system software interrupt. This can be accomplished by setting a bit, for example. In addition, the calling program needs to specify a service id, through, for example, the accumulator, or A register. An example is as follows:
; to request a system service, the kernel executes MOV A, #service_id. SETB Sysint

When the system interrupt occurs, it causes three things to happen synchronously,

1. The operating mode switches to the system mode.

2. The memory map changes to that for the system mode, as the result of operating mode change.

3. Execution jumps to a particular entry address of the system interrupt defined by the system program.

This allows the execution to continue at a different mode and at a different address in a different memory map.

More importantly, with this mechanism, there is only one allowed entry address from the kernel program in the kernel mode to system program in the system mode. This prevents malicious user kernel programs to randomly jump into system memory and cause unexpected program executions.

The system program, after finishes its service, will execute a RETI to return to the User OS, or the kernel program. If the kernel program and the system program needs to pass data to each other, they can pass them by either registers in the CPU 12 or by the SRAM memory 20 which is a shared memory.

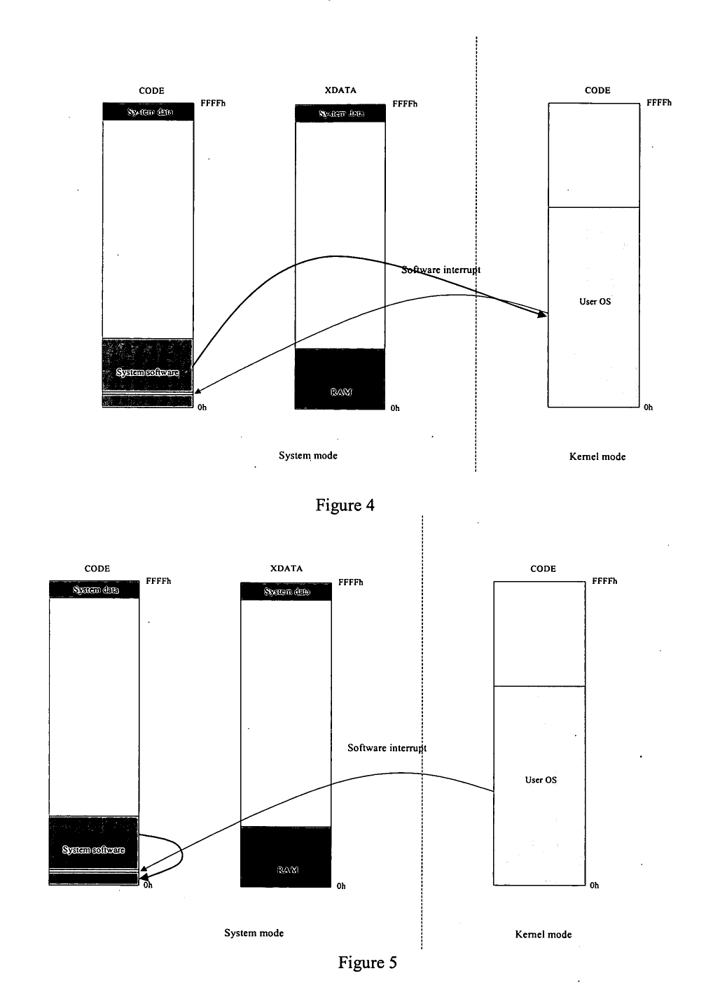

Before the system interrupt occurs, the interrupt controller will save the address of the next instruction in sequence in the stack in the kernel program operation. In addition, it will save the mode before the interrupt into a “saved mode”, register. Thus, after the system program finishes its service of the interrupt and execute a RETI (return from interrupt), the return address will be taken from the stack and put back to the program counter and the saved mode bit will be taken out of the buffer and put back into the system mode register. As a result, the execution returns back to the kernel program and the operating mode is restored. This is shown in FIG. 4.

Note that the kernel program in the kernel mode cannot directly write to the mode bits stored in the Mode Register 22 in such a way to cause the operating mode change to the system mode.

The advantage of the present invention whereby the kernel program operating in the kernel mode invoking a system interrupt with the MMU 14 changing the mapping of the memory map is that while in operation in the kernel mode, the kernel program in the kernel mode cannot read out the system program that is stored in the system mode, but can call on it to execute data and supply the results back to the kernel mode. For example, a manufacturer of the Chip 10 can install a certain type of encryption program and its private key in the system program. Because the user operating program (kernel program) operating in the kernel mode or the user application program operating in the User mode cannot read that program or the key, that program and key is protected. Yet at the same time, the user operating system program operating in the kernel mode or the user application program operating in the user mode can access the encryption services provided by the system software using the protected key, and return the results of that execution to the user.

In addition, it should be noted that the system program can alter the return address saved in the stack, as well as the saved mode bit. Thus the system program can decide to branch to other addresses, or to a different operating mode if so desired. This may happen, for example, if the system program after being called by the kernel program detects a violation of hardware (for example, a sensor) or software resources (corrupt data, or malicious worn/virus). The system program can then cause the system program to stay in the system program to deny the user program (either in the kernel mode or the user mode) from continuing execution. This is shown in FIG. 5.

Reset and Bootloading Sequence

One of the important functions of system program is to initialize the system during the startup/bootloading process. As such, the hardware reset causes the execution start at an address in the system mode. The code in system memory will carry out the start up sequence. After the start up sequence is finished, the following mechanism allows the execution to be directed to the kernel program code at address 0 in the Kernel mode.

The device is in system mode after reset. And the execution starts at address 0. From there, the system program can set up the device, load trim values to analog circuits and hand control to the kernel program in the kernel mode.

After the system program finishes the initialization, it should call a system interrupt. Within the system interrupt, it should clear the saved mode bits so that on return, the mode changes to kernel mode, and execute a RETI to enter into the user Operating System program in the kernel mode. Before RETI is executed, the kernel program needs to put the destination address, 0h to the stack, making appropriate adjustment to the stack pointer and execute RETI.

One example of a code to switch from system mode to kernel mode from reset is as follows:

ORG 0

AJMP System_start

ORG 2 Bh

AJMP Sys_int; Handler of System interrupt

; Other interrupt vectors.

ORG 30 H

System_start:

; . . . Startup code goes here

SETB SYSINT; Invoke Software Interrupt.

. . .

Sys_int:

CLR SYSINT

. . .

MOV SPSW, #0h; force the mode after return to be 0—kernel mode

MOV R0, SP; force return address to be 0

MOV @R0, #0

DEC R0

MOV @R0, #0

RETI; this will cause a branch to address 0 in kernel mode,
; thus start the user OS program.

. . .

Secure (Crypto) Key Management

In another example of the use of the integrated circuit device 10 of the present invention, a crypto coprocessor can access the system program in the system mode only. The system program contains a private key which is loaded during the factory installation of the system program. Thus, only the crypto coprocessor can access the private key in the system mode.

The kernel software running in the kernel mode, or the user application program running in the user mode, can access the encryption/decryption resources of the device 10 through a call to a system interrupt. However, the system interrupt will cause program execution to a single pre-designated (by the system program) entry point in the system program. After the service of the encryption/decryption service interrupt, program execution continues to either the kernel software or the user application program that initiated the system interrupt. Thus, the user cannot copy, read, or reinstall the private key.

### BEST MODE FOR CARRYING OUT THE INVENTION

CPU Architecture: Multi-Mode Secure Operation

Definition

The secure operation of Theseus Platinum 170&260 CPU is based on the concept of modes. TP170&260 CPU has 3 operating modes: the kernel mode, the user mode, and the system mode.

Two SFR bits M0 and M1 control the device operating modes. The mode bits are part of the PSW and EPSW (Extended Program Status Word).

PSW

Address: D0h

Reset value: 00h (The device starts up in system mode¹.)
¹ After the factory-installed firmware or system program executes its start sequence, it will hand control to the user OS or kernel program by switching to kernel mode. To the user, including user OS, the system starts in kernel mode with PSW=00h.

Access restrictions: M0 bit—System and Kernel change only.² All other bits—No access restrictions.
² This means we have to be able to selectively protect certain bit(s) in a SFR, so that the application running in user mode cannot change the value of the selected bit(s).

| | | | | | | | |
|---|---|---|---|---|---|---|---|
| (MSB) | | | | | | | (LSB) |
| CY | AC | F0 | RS1 | RS0 | OV | M0 | P |

| | |
|---|---|
| CY | Carry flag. |
| AC | Auxiliary carry flag (for BCD operations). |
| F0 | User definable flag |
| RS1 | Register bank select. Set/Cleared by software to determine |
| RS0 | working register bank. |
| OV | Overflow flag. |
| M0 | Mode bit. |
| P | Parity flag. |

EPSW

Address: E8H

Reset value: 20H (The device starts up in system mode.)

Access restrictions: M1—System change only. All other bits—No access restrictions.

| | | | | | | | |
|---|---|---|---|---|---|---|---|
| (MSB) | | | | | | | (LSB) |
| — | — | M1 | — | F3 | F2 | F1 | AM |

| | |
|---|---|
| M1 | Mode bit 1. System change only |
| F3 | System-change only general purpose bit. |

| | |
|---|---|
| F2 | System-change only general purpose bit. |
| F1 | General purpose bit with no access restriction. |
| AM | Addressing mode. 0 - Native 8051 addressing. 1 - |
| | Extended linear addressing. No access restriction. |

| M1 | M0 | Mode |
|---|---|---|
| 0 | 0 | Kernel mode. |
| 0 | 1 | User mode. |
| 1 | 0 | System mode. |
| 1 | 1 | Reserved - Same as system mode. |

Principle of Operation

The system mode is intended for factory-installed system program or firmware and libraries to run. Reset, start up and fault interrupts are also handled in the system mode.

The kernel and user modes are the modes under which user's OS program or kernel program and user application programs run. The kernel mode is more privileged than the user mode. Timers and ISO interrupts are handled in the kernel mode.

When the device is operating in kernel mode, it has access to most system resources, include rights to read from and write to SFRs and memories.

When the device is operating in the system mode, the software can access all system resources, including hardware interfaces as well as all those that are kernel accessible.

When the device is operating in user mode, it cannot access certain SFRs and memories as defined by the access restriction settings, which we will further discuss. Attempt to access these resources by an application running in user mode will cause a fault interrupt.

Restrictions for applications running in user mode are,
User applications cannot access and modify MMU settings.
User applications cannot modify interrupt enable and interrupt priority SFRs.
User applications cannot access memories not permitted by MMU settings.
User applications cannot change mode bit M except through a software interrupt.

For more information on these restrictions, see discussions on MMU and SFRs.

The memory map is different for different modes of operating. In other words, as the device operating mode changes, the memory map will change automatically.

Multi-mode operation is useful for design system software that has an OS and one or more applications managed by the OS. Below is a concept drawing of the relationship between OS and application.

As shown in FIG. 7, the OS manages the execution of the applications and shield the hardware from the applications. If an application wants the access the hardware (for example, memory read and write at certain region), it has to do it through the OS.

The OS, especially the part of the OS that performs critical hardware manipulation functions is executed in kernel mode. Applications generally run in user mode.

Operating Modes and Interrupts

The device operating modes and the interrupts are highly related. The hardware automatically set and clear the mode bits M0 and M1 upon entering to and exiting from interrupts.

Let us first define the concept of “interrupt states” of the 80C51 core. There are 4 interrupt states (if we count the normal, no interrupt state as a state).
1. Normal program execution state (no interrupt).
2. Low priority interrupt state.
3. High priority interrupt state.
4. System interrupt state.

At any time, the 80C51 core is in one of these 4 interrupt states. And there are bits in the interrupt controller that encode the current interrupt state. In other words, the hardware “knows” what interrupt state the device is in.

Note: It is important that interrupt nesting is not allowed in this device. In other words, an interrupt cannot pre-empt another interrupt of the same level of priority.

Note: The standard/classical 80C51 core supports 2 levels of interrupts. TP170&260 needs to support 3 levels of interrupts, with the addition of system level interrupt, which has the highest priority level.

When the device enters into an interrupt state (excluding the normal/no interrupt state), the device operating mode will be determinately set as the following.

| Interrupt state | Operating Mode | M1, M0 |
|---|---|---|
| Low priority | Kernel | 0, 0 |
| High priority | Kernel | 0, 0 |
| System interrupt | System mode | 1, 0 |

So the low priority and high priority interrupts are handled in kernel mode only. System interrupts are handled in system mode only. Normal executing can occur in all modes. No interrupt handling will occur in the user mode.

For each interrupt state, excluding the normal operating state, there are 2 SFR bits called Saved M0 and Saved M1 bit or SM0 and SM1 bit. And since we have 3 interrupt states if we exclude normal operating state, we have 3 sets of SM0 and SM1 bits. They are SM0_lowint and SM1_lowint for low priority interrupts; SM0_highint and SM1_highint for high priority interrupts; and SM0_sysint and SM1_sysint for system interrupts.

On entering an interrupt, the current mode (the mode before entering the interrupt) bits M0 and M1 are automatically saved in the SM0 and SM1 bits corresponding to the interrupt state the processor is entering into. And the mode bits will be set for the corresponding interrupts state that the device is entering into.

On exiting from interrupt, the save mode bits corresponding to the current interrupt state will be used to restore the value in mode bits.

For example, the device is entering from low priority software interrupt state (in kernel mode) to system interrupt state (in system mode):

Enter:
(M1, M0) (which is (0, 0)) -> (SM1_sysint, SM0_sysint)
Return address ->stack
(1, 0) -> (M1, M0) ; now in system mode
Exit:

(SM1_sysint, SM0_sysint) (which is (0, 0))→(M1, M0)

Stack→return address; now in kernel mode

SM bits are part of a SFR called SPSW, shown below.

SPSW

Address: D8h-bit addressable

Reset Value: xx0xxx0xB

Access restriction: SM1-System change only SM0-System and Kernel change only.

| | | | | | | | |
|---|---|---|---|---|---|---|---|
| — | — | SM1 | — | — | — | SM0 | — |

There are 3 SPSW registers, SPSW_lowint, SPSW_highint and SPSW_sysint. They are banked, such that at any given time, one or none of them is visible to the software program, depending on the interrupt state (this approach is similar to dual DPTR implementation, except the register selection is controlled automatically by the interrupt controller). 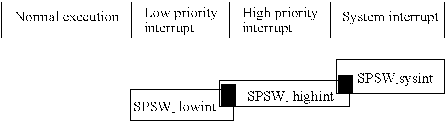
SPSW_lowint, SPSW_highint and SPSW_sysint are banked, and occupy a single SFR address, D8h3. SPSW_highint is visible to the running program in high priority interrupt state, SPSW_lowint is visible to the running program in low priority interrupt state and SPSW_sysint is visible to the running program in system interrupt state. In normal running mode, none of them is accessible.

SM1 and SM0 bits are changeable by interrupt handlers running system mode. SM0 bit is changeable by interrupt handlers running in kernel mode also.

Operating Mode Switching Mechanism

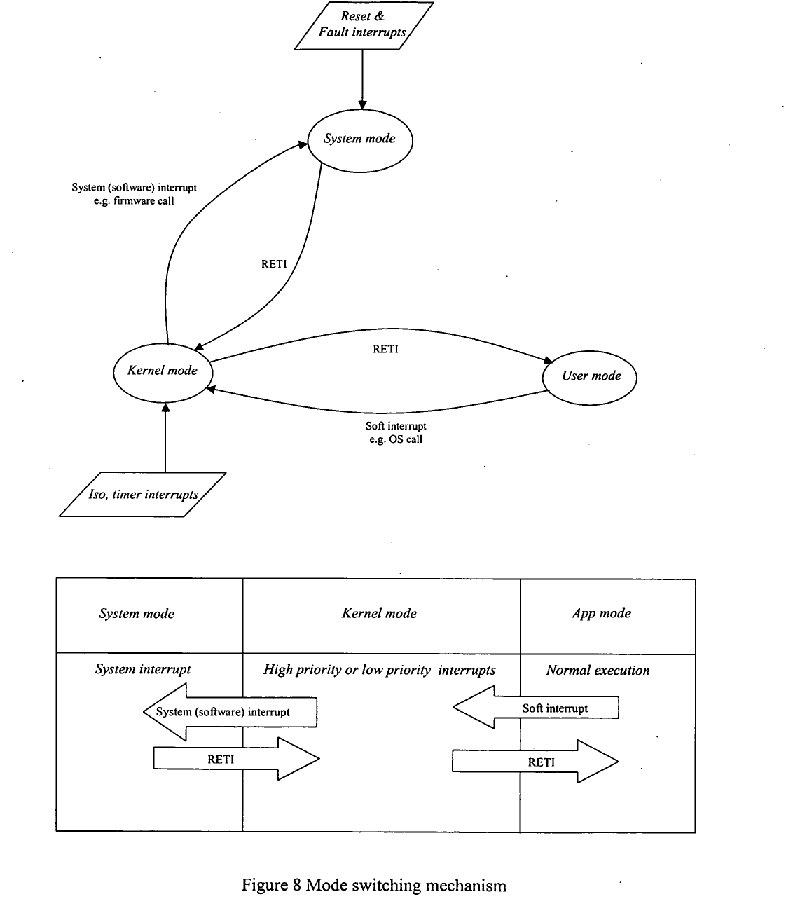

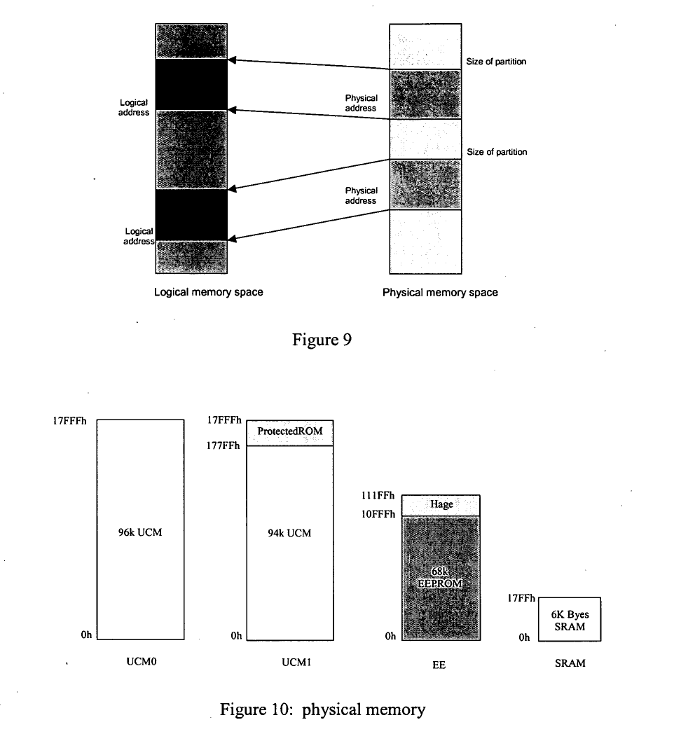

As described in the last section, interrupts cause changes in operating mode. In fact, interrupts are used as a mechanism to change operating mode. Referring to FIG. 8 there is shown a graph of the mode switching mechanism.

There are software interrupts in this device. Thus the software can voluntarily change operating modes.

Although it is possible to directly set/clear mode bits in system and kernel mode, we recommend that the developer only rely on software and system interrupts to switch operating modes. This is mainly because that mode change will change memory map. A software or system interrupt can be thought as a branch call synchronized with mode switching.

User software interrupt is invoked by setting an interrupt flag bit in a SFR (SETB USINT). System software interrupt is invoked by setting an interrupt flag bit in a SFR (SETB SSINT). For details, please refer to the chapter on interrupts.

Advice to developer: Interrupt handling is not allowed in application codes.

Execution of RETI in normal execution state (i.e. not inside an interrupt handler) is not allowed, and will cause a fault interrupt.

Operating Mode Switching Mechanism—from Reset

The device is in normal execution state and in system mode after reset. And the execution starts at address 00H. From there, the firmware can set up the device, load trim values and hand control to the kernel.

After the firmware finishes the initialization, it should call a system interrupt. Within the system interrupt, it should clear the SM bits, and execute a RETI to enter into the OS in kernel mode. Before RETI is executed, the kernel needs to put the destination address, 0h to the stack, make appropriate adjustment to the stack pointer and execute RETI.

The OS/application in kernel/user mode will call system interrupt to request any system/firmware service. Any execution of RETI from the interrupt handler will take the processor back to the OS/application in kernel/user mode.

Code to Switch from System to Kernel Mode from Reset

ORG 0

AJMP System_start

ORG 2Bh

AJMP Sys_int; Handler of System interrupt

; Other interrupt vectors.

ORG 30H

System_start:

MOV IP, #3EH

MOV IE, #3FH; Enable interrupts.

SETB EA

SETB SYSINT; Invoke Software Interrupt.

. . .

Sys_int:

CLR SYSINT

. . .

MOV SPSW, #0h

MOV R0, SP

MOV @R0, #0

DEC R0

MOV @R0, #0

RETI

. . .

Operating Mode Switching Mechanism—Between Kernel and User

The device is in normal execution state and in kernel mode after system startup. And the execution starts at address 0h.

If the OS wants to hand control to user application in user mode, it should call a software interrupt. Within the software interrupt, it should set the SM0bit, and execute a RETI to enter into the application in user mode. Before RETI is executed, the kernel needs to put the destination address to the stack, make appropriate adjustment to the stack pointer and execute RETI.

The application in user mode will call software interrupt to request any kernel service. Any execution of RETI from the interrupt handler will take the processor back to the application in user mode.

Code to Switch to Application in User Mode

ORG 0

AJMP Kernel_start

ORG 03H

AJMP Soft_int; Handler of Software interrupt

; Other interrupt vectors.

ORG 30H

Kernel_start:

. . .

SETB SINT; Invoke Software Interrupt.

. . .

Soft_int:

CLR SINT

. . .

SETB SM0

MOV R0, SP

MOV @R0, #HIGH(App_start)

DEC R0

MOV @R0, #LOW(App_start)

RETI

. . .

App_start:

. . .

SETB SINT; Invoke software interrupt
; to request kernel service.

. . .

Interrupt Summary

The device has an interrupt controller that is based on the standard 80C51 interrupt controller. It supports interrupts with 3 levels of priorities: low priority interrupt, high priority interrupt and system level interrupt (exceptions). System interrupts are non-maskable and handled in system mode only.

Below is a list of the interrupts and their vector addresses.

| | | Vector | | Clear flag | Polling |
|---|---|---|---|---|---|
| Source | Name | address | Priority | by | order |
| User | USINT | 0003h | Low or | Software | (high) |
| software | | | High | | |
| interrupt | | | | | |
| Timer 0 | IT0 | 000Bh | Low or | Hardware | |
| | | | High | | |
| Memory fault | MFLT | 0013h | Low or | Software | |
| Interrupt | | | High | | |
| Timer 1 | IT1 | 001Bh | Low or | Hardware | |
| | | | High | | |
| ISO Serial | ISP (RI | 0023h | Low or | Software | (low) |
| | or TI) | | High | | |
| Physical fault | PFLT | 002Bh | System | Software | |
| conditions, | | | | | |
| frequency, | | | | | |
| temperature, | | | | | |
| voltage, UV | | | | | |
| tampering. | | | | | |
| System | SSINT | 0033h | System | Software | |
| software | | | | | |
| interrupt | | | | | |
| NvControl | NVINT | 003Bh | Low or | Software | |
| Interrupt | | | High | | |

### Table 3.1 Interrupts in Platinum 170&260D

To be consistent with 80C51, reset is not considered an interrupt.

80C51 Review: An interrupt condition will set an interruptflag bit in the SFR space. Interrupt flags can also be set and cleared by software (when kernel permits), since they are SFR bits. The effects are the same.

Each of these interrupts can be enabled/disabled by software by setting/clearing the enable bits in the SFR IE. There is a bit (EA) in IE that can disable all interrupts when cleared.

Interrupt Enable Register

IE

Address: A8h

Reset value: 0x000000B

Access restrictions: System access only.

| | | | | | | | |
|---|---|---|---|---|---|---|---|
| (MSB) | | | | | | | |
| EA | — | ENVI | ES | ET1 | EMINT | ET0 | ESINT |

| | |
|---|---|
| EA | EA=0: all interrupts disabled. EA=1: Each interrupt is |
| | individually enabled/disabled by setting/clearing its |
| | enable bit. |
| — | — |
| ENVI | Nv control interrupt enable. 1 - enabled, 0 - disabled. |
| ES | ISO Serial interrupt enable bit. 1 - enabled, 0 - disabled. |
| ET1 | Timer 1 interrupt enable. 1 - enabled, 0 - disabled. |
| EMFLT | Memory fault interrupt enable. 1 - enabled, 0 - disabled. |
| ET0 | Timer 0 interrupt enable. 1 - enabled, 0 - disabled. |
| ESINT | Software interrupt enable. 1 - enabled, 0 - disabled. |

An interrupt can have low or high priority. This means two things
1. A high priority interrupt can interrupt a (on-going) low priority interrupt.
2. When a high priority interrupt and low priority interrupt condition are detected simultaneously (meaning they are detected at the same CPU cycle), the high priority interrupt are serviced.
3. When interrupts of same priority are detected at the same time, interrupt with higher polling priority will be serviced. See Table 3.1 for polling priorities.
   Interrunt Priority Register
   IP

Address: B8h

Reset Value: XX000000B

Access restricitions: System access only.

| | | | | | | | |
|---|---|---|---|---|---|---|---|
| — | — | PNVI | PS | PT1 | PMFLT | PT0 | PSINT |

| | |
|---|---|
| — | Not implemented. |
| — | — |
| PNVI | NvControl interrupt priority. 1 - high priority, 0 - low priority. |
| PS | ISO Serial interrupt priority. 1 - high priority, 0 - low priority. |
| PT1 | Timer 1 interrupt priority. 1 - high priority, 0 - low priority. |
| PMFLT | Memory fault interrupt priority. 1 - high priority, 0 - low |
| | priority. |
| PT0 | Timer 0 interrupt priority. 1 - high priority, 0 - low priority. |
| PSINT | Software interrupt priority. 1 - high priority, 0 - low priority. |

Interrupt Polling Priority

When more than one interrupt at the same priority level are detected, they are polled at a fixed order such that interrupts of higher polling priority are serviced. See Table 3.1 for assignment of polling priorities.

Analysis of the Corner Cases

The following are the scenarios that require special caution.

Changing Mode by Direct Write to the Mode Bits.

This is not possible for application running in user mode.

Although this is possible for code running in kernel mode, special caution is required. Changing mode will cause a change in MMU mapping (for more, see MMU spec. in Chapter 2). In order for the execution to continue correctly, special care has to be taken to ensure that the program can continue execute in a meaningful way after the memory mapping change.

Software or Hardware Interrupt in User Mode

This is possible but we do not see any benefit of doing this. When running in the kernel mode while handling an interrupt, the handler can set the kernel mode bit M via a write to the SFR containing this bit, thus put the device in user mode.

Switching to the user mode involves changing the MMU mode. In order for the execution to continue correctly, special care has to be taken to ensure that the program can continue to execute in a meaningful way after the memory mapping change.

The interrupt handlers should be part of the kernel and protected. The user application should not be allowed to modify interrupt handlers.

Execution of RETI in Normal Execution State

Execution of RETI when the program is not in an interrupt handling state and in user mode, is not allowed. This will cause a fault interrupt.

Execution of POP PSW in User Mode

If a program attempts to write to mode bits in user mode with POP PSW, it will have no effect. Any write to PSW in user mode will not affect the mode bits.

However, if POP PSW and any other writes to PSW do not attempt to alter the value of the mode bits, a fault situation will not happen.

Summary of Things to Implement

Implement the M0 bits, i.e. PSW.1 if it is not already implemented

The PSW should be an 8-bit SFR register. If not, implement the missing bit. The output of PSW.1 should be made available as an output port from CPU block.

Implement EPSW

M1 bit should be made an output of the CPU.

Implement SPSW_Lowint, SPSW_Highint and PSW_Sysint, and Map them to SFR Address D8h Depending on the Interrupt State

A total of 3 SFRs are to be implemented, although each has only 3 bits.

The 8051 interrupt controller should have a couple of bits indicating the CPU interrupt state (no interrupt, low priority interrupt, high priority interrupt, system interrupt). Use these bits to control whether SPSW_lowint, SPSW_highint, SPSW_sysint (or none of them) is mapped to SFR address at D8h.

Implement Mode Bits Auto Save and Restore

Upon entering a low or high priority interrupt:

SM1, SM0←M1, M0

M1, M0←(0, 0)

Upon entering a system interrupt:

SM1, SM0←M1, M0

M1, M0←(1, 0)

Upon execution of RETI

M1, M0←SM1, SM0

Mode bits change has to be performed before fetching the next instruction.

Trigger a Fault Condition when RETI is Executed in Normal, No Interrupt State

The output of this trigger would set a flag to drive fault interrupt (more details in chapter 3).

TP170&260 SFR Access Control

An access restriction level is defined for each SFR in this device. In some cases, an individual bit in a SFR has a unique access restriction level defined.

There are a total of 5 access control levels, they are:
1. System access only—A SFR is accessible only when the device is in system mode. Attempt to read or write to the SFR in a mode other than the system mode will cause a memory fault interrupt, when enabled.
2. Kernel and System access only—A SFR is accessible when the device is in system or kernel mode. Attempt to read or write to the SFR in the user mode will cause a memory fault interrupt, when enabled.
3. System change only—An individual SFR bit can only be changed when the device is in system mode. Attempt to write to this SFR bit in a mode other than the system mode has no effect. It will NOT cause a memory fault interrupt however. This bit is always readable.
4. Kernel and System change only—An individual SFR bit can only be changed when the device is in system or kernel mode. Attempt to write to this SFR bit in the user mode has no effect. It will NOT cause a memory fault interrupt however. This bit is always readable.
5. No restriction.

When implementing the logic to support these access controls, only the mode bits, M1 and M0 are needed to gate the accesses and generate the fault signal.

In TP130, we have a signal called PCIsInProtectedROM. This signal and the associated logic to generate this signal are not needed and should be taken out for TP170&260.

The table below shows the relationship between TP130 access restrictions and TP170&260 access restrictions. For information about access restriction level for SFRs and SFR bits, please refer to this specification only.

| TP170&260 access restriction | TP130 access restriction |
|---|---|
| System access only | BootROM access only |
| Kernel and System access only | Kernel access only |
| System change only | — |
| Kernel and system change only | Kernel change only |
| No restriction | No restriction |

Interrupt Blockage Behavior

Please note the following behavior.
1. During normal execution of RETI, interrupt is blocked. Execution of RETI outside the ISR generates a RETIFLT. So an illegal RETI will not block the interrupt. There will not be any operations on SPSW and M-bit, but PC will be loaded with stack contents.
2. Normally write in IE and IP SFRs blocks the interrupt. But an illegal access to these SFRs (access during user mode) will discard the write, will generate SFRFLT and interrupt will not be blocked.
   CPU Architecture: Linear Address Expansion
   Overview

TP170&260 CPU has 2 different addressing modes: the standard 80C51 16-bit addressing mode and the linear contiguous expanded addressing mode. The addressing mode bit AM, which is part of the SFR EPSW, controls the CPU addressing mode.

When the AM bit is set, the CPU operates in linear addressing mode. When AM is cleared, the CPU operates in native 8051 mode, with 16-bit addressing, for 100% backward compatibility.

On reset, AM is cleared the and the CPU is in 8051-mode. Details of linear addressing mode is provided below.

Since interrupt handlers are definitely smaller, it maybe better to write the interrupt handlers in native 16-bit addressing modes. In this case, the interrupt handler is responsible for saving and restoring the addressing mode bit on entering to and exiting from the interrupt.

Program Addressing Expansion

Several expansions to the architecture are made the CPU capable of addressing up to 16M of program and data memory, when AM bit is set.

First, the program counter (PC) is expanded to 24 bits, when the AM bit is set. An 8-bit PCX⁴ register is added. So the complete PC is PCX:PCH:PCL. In the linear addressing mode, PCX will be used to drive the high order code memory address bits.
⁴ Since TP260 has less than 512 k of memory for code, only three bits PCX.0, PCX.1, PCX.2 are actually implemented.

As the PC increments, it will grow linearly from 0 to the top of 16M. PC increments are 24-bit add operations, when the AM bit is set.

In the standard 80C51 mode, i.e. when the AM bit is cleared, the lower 16-bit of the PC (PCH:PCL) is used to drive the lower 16 bit of the memory bus. PCX becomes a SFR called CBSL. The higher bits of the memory bus are controlled by CBSL register (see MMU chapter for details). CBSL can be read and write in standard 80C51 mode.

In 16-bit standard 8051 mode, PC operations are 16 bit, and will not propagate to influence PCX (now CBSL).

As the width of the PC changes, several other modifications have to be made. These changes will be in effect when the CPU is in linear addressing mode.
1. LCALL #addr24, LJMP #addr24 go to 24 bit destination addresses.
2. ACALL #addr19, AJMP #addr19 go to 19 bit destination addresses.
3. LCALL, ACALL will push 3 bytes of PC to the stack.
4. Interrupt pushes 3 byte PC address to stack.
5. RET and RETI pops 3 byte of address from stack to PC.
   Data Addressing Expansion

Two 8-bit registers, DPX0, DPX1⁵ are introduced to expand DPTR to 24-bit. In the linear addressing mode, DPTR becomes 24-bit. All the @DPTR addressing will select a 24-bit data address.
⁵ Since the total data memory is less than 512 k in TP260, only 3 bits DPX.0, DPX.1 and DPX.2 need to be implemented in the DPX registers.

DPX0

Address: 93

Default value: 00h

Access: No restriction

| | | | | | | | |
|---|---|---|---|---|---|---|---|
| — | — | — | — | — | DPX0.2 | DPX0.1 | DPX0.0 |

DPX1

Address: 95h

Default value: 00h

Access: No restriction

| | | | | | | | |
|---|---|---|---|---|---|---|---|
| — | — | — | — | — | DPX1.2 | DPX1.1 | DPX1.0 |

MOV DPTR, #24 will replace MOV DPTR, #16 in linear addressing mode, so DPTR can be loaded with a 24-bit value in one instruction.

INC DPTR will be a 24-bit DPTR addition, when the AM bit is set.

For MOVX A, @Ri and MOVX @Ri, A, the address bits 16 to 18 will be determined by the bits in MPTRX register. Address 8 to 15 will be determined by the MPTR as usual.

MPTRX

Address: EAh

Default value: 00h

Access: No restriction

| | | | | | | | |
|---|---|---|---|---|---|---|---|
| — | — | — | — | — | MPTRX.2 | MPTRX.1 | MPTRX.0 |

Drive Source for the Extended Address Bits

The CPU core will generate a 19-bit address bus. All 19 bits of the address bus are driven regardless of whether the device is in 8051 or linear mode.

The upper three bits of this address bus behave differently in Native 8051 mode and the Linear (19-bit) mode.

In Native Mode:

CPUAddress[18:16]=PCX/CBSL[2:0]

In this mode software can directly write to PCX/CSBL SFR. The PCX and CBSL are two names for the same register. So in this cause, the extended address bits are always driven by the same SFR.

In Linear Mode:

| Operation | Source |
|---|---|
| Opcode fetch | PCX/CBSL[2:0] |
| MOVX @DPTR | DPX[2:0] |
| MOVX @Ri | MPTRX[2:0] |
| MOVC @DPTR | DPX[2:0] |
| MOVC @PC | PCX/CBSL[2:0] |

In this mode user cannot write to PCX/CBSL SFR.

Behaviors of Short Jumps and Operations on PC and DPTR in Linear Addressing Mode

Examples are SJMP, CJNE, DJNZ, JB, JBC, JNB, JZ, JNZ.

Short jumps should cause PC to cross 64 k boundaries.

An interesting testing/verification condition: if a short jump is interrupted and its target address is in the next 64 k page, on return from interrupt, make sure execution goes to the next 64 k page.

In instructions JMP @A+DPTR, MOVC A, @A+DPTR and MOVC A, @A+PC, the add operations are in 24-bits⁶, when the device is in linear addressing mode.⁷
⁶ Since PC, DPTR are actually 19 bits in 260, all those “24-bit operations” will be actually 19-bit operations. So we are pretending we are doing 24-bit operations (add, increment), and then truncate the highest 5 bit; and therefore we end up with 19-bit operations. This is possible because we are not doing any signed operations on PC and DPTR.

⁷ When the device is in 8051 compatibility mode, A+DPTR and A+PC are 16 bit operations. The high order addressing bits are driven by DPX and PCX but not affected by these instructions.

Interrupts and Linear Addressing

In linear addressing mode, upon servicing an interrupt, the PC is loaded with interrupt vector addresses where the upper bits (PCX) are all 0's. The 3 byte return address is stored in the stack and occupies 3 bytes of stack space.

In 8051 mode, on interrupt, only the 16 bit PC is loaded with the interrupt vector address. CBSL stay unchanged. The actual address on the bus is CBSL:PC. The user should make the memory at the vector address common to all 64 k banks (i.e. 16-bit address mode).

| Mnemonic | Encoding | Byte | Cycle | Definition |
|---|---|---|---|---|
| ACALL | a18 a17 a16 1 0 0 0 1 | 3 | tbd | PC=PC+3 |
| #addr19 | a15 a14 a13 a12 a11 a10 a9 a8 | | | SP=SP+1 |
| | a7 a6 a5 a4 a3 a2 a1 a0 | | | (SP)=PCL |
| | | | | SP=SP+1 |
| | | | | (SP)=PCH |
| | | | | SP=SP+1 |
| | | | | (SP)=PCX |
| | | | | PC18:0=addr19 |
| AJMP #addr19 | a18 a17 a16 0 0 0 0 1 | 3 | tbd | PC=PC+3 |
| | a15 a14 a13 a12 a11 a10 a9 a8 | | | PC18:0=addr19 |
| | a7 a6 a5 a4 a3 a2 a1 a0 | | | |
| INC DPTR | 1 0 1 0 0 0 1 1 | 1 | tbd | DPTR=DPTR+1 |
| LCALL | 0 0 0 1 0 0 1 0 | 4 | tbd | PC=PC+4 |
| #addr24 | a23 a22 a21 a20 a19 a18 a17 a16 | | | SP=SP+1 |
| | a15 a14 a13 a12 a11 a10 a9 a8 | | | (SP)=PCL |
| | a7 a6 a5 a4 a3 a2 a1 a0 | | | SP=SP+1 |
| | | | | (SP)=PCH |
| | | | | SP=SP+1 |
| | | | | (SP)=PCX |
| | | | | PC=addr24 |
| LJMP #addr24 | 0 0 0 0 0 0 1 0 | 4 | tbd | PC=addr24 |
| | a23 a22 a21 a20 a19 a18 a17 a16 | | | |
| | a15 a14 a13 a12 a11 a10 a9 a8 | | | |
| | a7 a6 a5 a4 a3 a2 a1 a0 | | | |
| MOV DPTR, | 1 0 0 1 0 0 1 0 | 4 | tbd | DPX = data 23:16 |
| #data24 | d23 d22 d21 d20 d19 d18 d17 d16 | | | DPH = data 15:8 |
| | d15 d14 d13 d12 d11 d10 d9 d8 | | | DPL = data 7:0 |
| | d7 d6 d5 d4 d3 d2 d1 d0 | | | |
| RET | 0 0 1 0 0 0 1 0 | 1 | tbd | PCX=(SP) |
| | | | | SP=SP−1 |
| | | | | PCH=(SP) |
| | | | | SP=SP−1 |
| | | | | PCL=(SP) |
| | | | | SP=SP−1 |
| RETI | 0 0 1 1 0 0 1 0 | 1 | tbd | PCX=(SP) |
| | | | | SP=SP−1 |
| | | | | PCH=(SP) |
| | | | | SP=SP−1 |
| | | | | PCL=(SP) |
| | | | | SP=SP−1 |

Memory Management Unit (MMU)
Memory Partition and Mapping with MMU

A memory management unit (MMU) is implemented to partition the physical memory space into different regions, implement protection mechanisms for these regions and map them into the CPU logical memory space with address translation.

As shown in FIG. 9, the logical memory space and the physical memory space for this device are separate. The physical memory is mapped to the processor core's logical memory space by MMU. The mapping can be configured by software at run time.

In order to partition and map a region of memory, at least three parameters have to be defined. They are,

Physical Address—This defines the start address of the memory partition in the physical space.

Size of Partition—This defines the size of the memory partition⁸.
8 Since there is only one size parameter, it is implied that the size of the logical partition is the same as the size of the physical partition.

Logical address—This maps the physical memory to the CPU's logical memory space.

Attributes to a Memory Partition

In addition to the above parameters for a memory partition, we also define, for each memory partition, the access restrictions and bus type.

Access Restrictions (Applies to Both Kernel and User Mode)

Read write—the memory can be read, executed from if configured as code or unified, and written to, i.e. no restrictions.
Read only—the memory can be read, executed from if configured as code or unified, but not written to.
Execute only—the memory, if configured as code type or unified type, can be executed from. No other access (read, write) is permitted. If the memory is configured as data, no access is allowed.

Designer's Note: If a block of memory is configured as code, it can be executed from or read by MOVC, unless restricted by MMU. When code memory is executed from, its address is generated from PC and its contents are fed to the instruction decode unit and sequencer to drive the instruction execution. When code memory is read, its address is generated from decoded address from MOVC instruction and its contents are fed to ALU and/or other circuits and eventually written to register A. There should be a way to selectively prohibit one or both type of accesses, per MMU settings.

Bus Type

Disabled, access will cause a fault
Code
Data—xdata
Unified

Note: If a memory is configured as code, its strobe is caused by read during program fetch and MOVC. If a memory is configured as data, both its read and write strobe are caused by memory access instructions MOVX.

If a memory partition is configured to be unified, its read strobe is OR'ed between those for code read and those for data read. The write strobe is the same as the data write strobe. As a result, this memory can be read, written and executed from, when permitted by the MMU settings.

Access Violations

If the application attempts to access memory in a way that violates the MMU settings, a fault interrupt condition will be set. And the device will enter into a hardware interrupt if that interrupt is enabled. The types of violations that could cause a MMU interrupt are,

Out of bound violation for code fetch and MOVC—the address for memory access is outside of any defined partition.

Out of bound violation for data access—the address for memory access is outside of any defined partition.

Access violation for data—the type of access is not allowed by MMU. For example, attempt to write to memory that is read only.

Access violation for code—the type of access is not allowed by MMU. For example, attempt to read from memory that is execution only.

Details about the fault interrupt can be found in Chapter 4 on interrupts.

MMU Partition Types

Depending on the CPU operation mode, the MMU behaves differently. There are 4 types of MMU partitions; each is active in a specific mode.

Fixed system partitions—These partitions are hardwired and active in system mode.

Fixed kernel partitions—These partitions are hardwired and active in kernel mode.

Kernel partitions—These are software-configurable partitions that are in effect when the device is in kernel mode.

Application partitions—These are software-configurable partitions that are in effect when the device is in user mode.

Common partitions—These are software-configurable partitions that are in effect in both kernel mode and user mode.

The TP260 device supports a total of 8 software-configurable partitions. Each can be configured to be active in kernel mode or application mode, or both.

The Physical Memory Map

The physical map of the device 10 of the present invention is shown in FIG. 10.

Not included here are 256 bytes of internal RAM.

Memory Map in System Mode

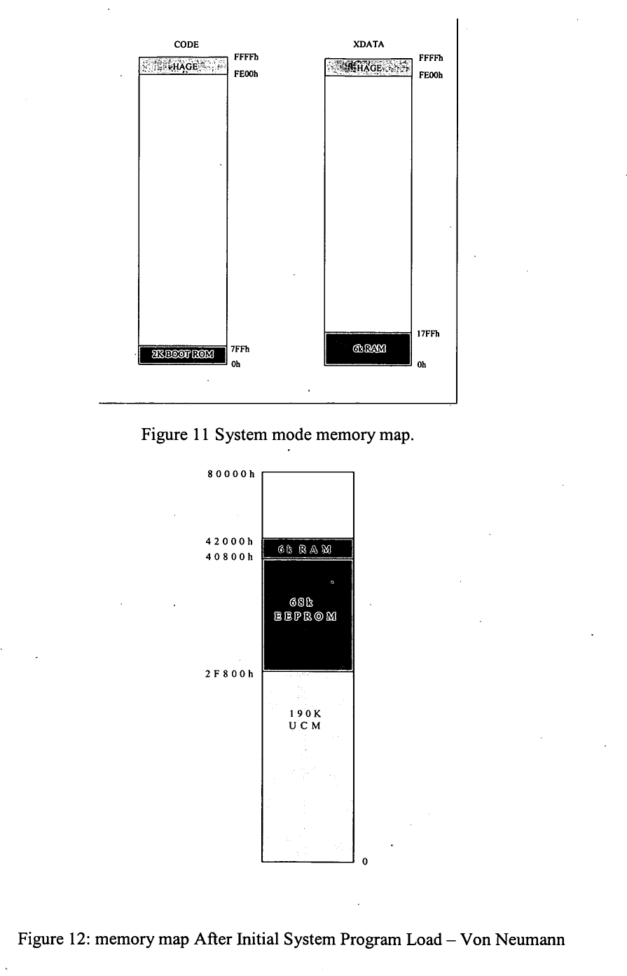

The memory space of TP260 in system mode contains 3 fixed partitions. Those memories are always present at the specified address in system mode (but not virgin state), see FIG. 11.

FIG. 11 shows the System mode memory map. The 2K ROM starts from address 0x00 and contains the boot code, which are mandatorily executed on reset. The HAGE utility memory is EEROM. Hage is necessary for flash programming.

Memory Map in Kernel Mode

When the device is in system mode, the boot code/firmware will set up the initial memory map for the kernel. In kernel mode, the application software or the boot loader can add or change memory partitions to the memory map.

Note: Since kernel can configure MMU settings, it can set up partitions differently for different tasks (e.g. downloading applications) without leaving the kernel mode; so long as the kernel is not executing from the partition that is affected by the change of MMU settings.

In user mode, the user can add memory partitions to the original memory map.

Note: Partitions for user applications are added while the OS is executing in kernel mode. These application partitions won't take effect until the operating mode changes from kernel to user mode.

If it is necessary to create a different set of partitions for user mode, the program has to give control back to the kernel and let the kernel to set up partitions.

Referring to FIG. 12 there is shown a memory map that will be set up by the system program and presented to the user when the product is first shipped (default memory map). The memory map is configured for a Von Neumann hardware architecture.

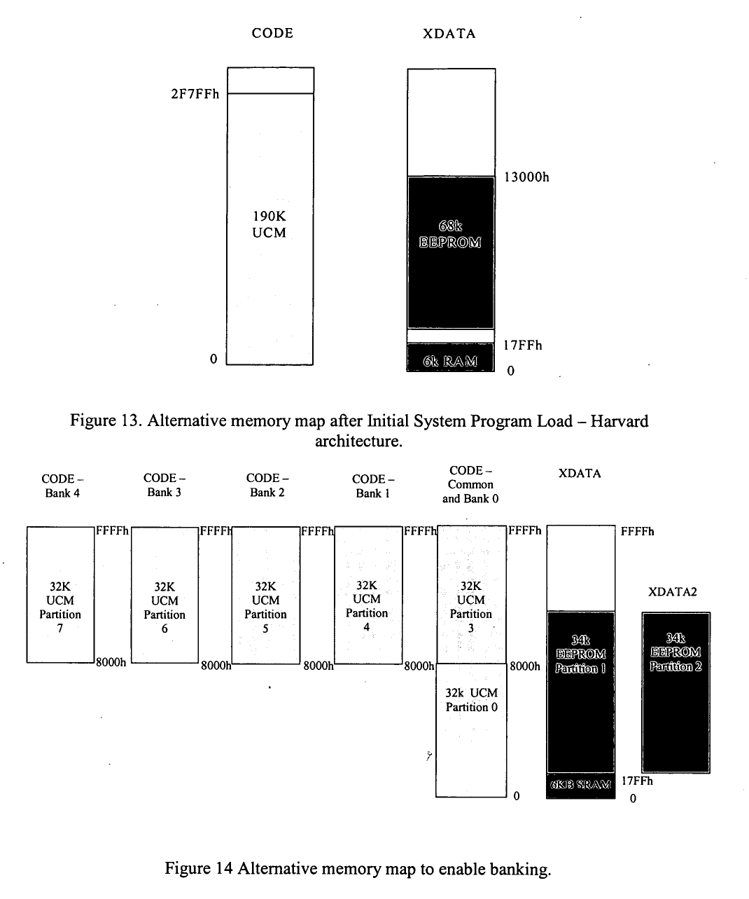

Referring to FIG. 13 there is shown a memory map that will be set up by the system program and presented to the user when the product is first shipped (default memory map). The memory map is configured for a Harvard hardware architecture.

Code Banking—a Backward Compatibility Feature

In order to address more than 64 k of memory, 3 more address ports are implemented internally to address up to 8 banks of 64 k memory block. Those 3 ports are called Code Bank Select Ports and it is controlled by a SFR called CBSL, which we will discuss below. This register is the same as the extended PC (PCX) in linear addressing mode.

For example, when a memory partition is configured to be Code-bank 1, it is addressed only when Code Bank Select Ports points to bank 1, that is, the Bank Select port outputs a (0 0 1).

When a memory partition is configured to be Code-common area, it is addressed regardless of the content of the bank select SFR. Thus this memory is mapped to all banks even though it is just one block of memory physically.

Code Bank Select SFR⁹
⁹ In native 8051 mode, the extended address bits are always controlled by CBSL. Therefore, data bank select is controlled by CBSL as well. In that, this SFR should really be called BSL.

CBSL

Address: A1H

Reset value: 00H

Access Restrictions: none

| | | | | | | | |
|---|---|---|---|---|---|---|---|
| (MSB) | | | | | | | |
| — | — | — | — | — | CBSL.2 | CBSL.1 | CBSL.0 |

| (CBSL.2, CBSL.1, CBSL.0) | Bank Selection |
|---|---|
| 0 0 0 | Bank 0 selected. |
| 0 0 1 | Bank 1 selected. |
| 0 1 0 | Bank 2 selected. |
| 0 1 1 | Bank 3 selected. |
| 1 0 0 | Bank 4 selected. |
| 1 0 1 | Bank 5 selected. |
| 1 1 0 | Bank 6 selected. |
| 1 1 1 | Bank 7 selected. |

If a memory partition is defined as banked code, it is addressed only when its banks is selected. The device support up to 8 banks, selectable by CBSL.2, CBSL.1 and CBSL.0.

Note that code bank select does not apply to common area code. Code in common area are always addressed, regardless of the content of bank select SFR.

Under Keil tool chain, bank switching is automatically handled by the linker (or more precisely, bank switching is handled by the code generated by the linker automatically). The user only need to make some modifications of the driver code L51_bank.a51. (Application support will provide L51_bank.a51 specifically adapted to this device).

Interrupt routines have to be located in the common area. Because of that, there is no need to save and restore bank select SFR upon entering into and exiting from interrupts. Referring to FIG. 14, there is shown an alternative mapping for the device 10 achieved by software configuration to enable banking.

MMU Configurations

Physical Address

The physical address is encoded into a 6-bit entity called PADR(5:0). The physical offset address is calculated as PADR*2048. Thus the maximum range is 0 to 128 k and the alignment requirement is 2048 (2 k) bytes.

Size of Partition

The size of partition is encoded into a 6-bit entity called SZ(5:0). The partition size in bytes is calculated as (SZ+1)*2048. Thus the maximum range is 2048 bytes to 128 k and the alignment requirement is 2048 bytes.

Logical Address

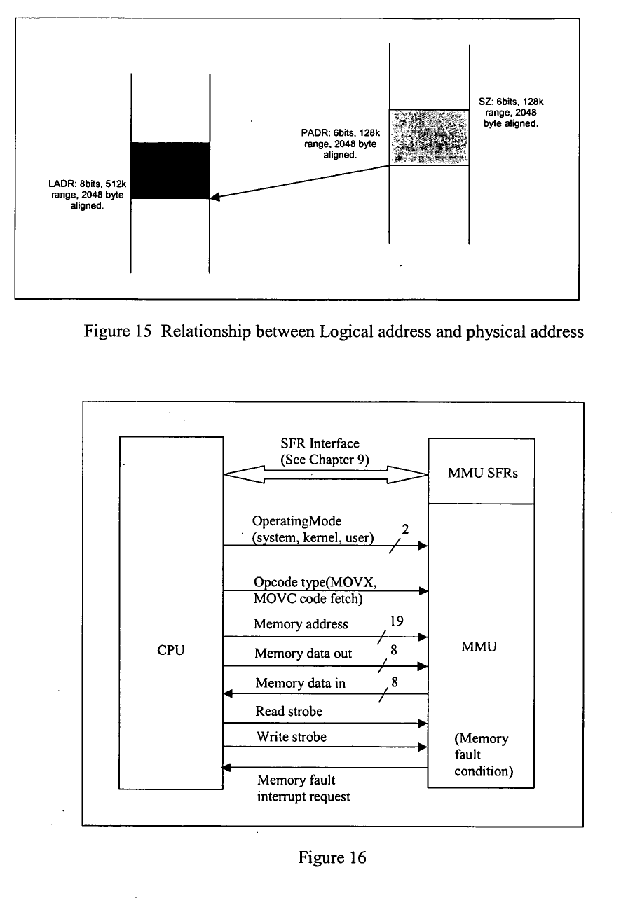

The logical address is encoded into a 8-bit entity called LADR(7:0). The logical address is calculated as LADR*2048. Thus the maximum range is 0 to 512 k and the alignment requirement is 2048 (2 k) bytes. Referring to FIG. 15 there is shown the relationship between the logical address LADR and the physical address PADR.

Memory Type MEM

This defines what type of physical memory should be used to form the partition.

| MEM | Memory type |
|---|---|
| 0 0 | UCM0 |
| 0 1 | UCM1 |
| 1 0 | EEPROM |
| 1 1 | RAM |

Parition Type PAR¹⁰
¹⁰ All system partitions are hardwired.

| PAR | Partition type |
|---|---|
| 0 0 | Inactive |
| 0 1 | Active in kernel mode¹¹ |
| 1 0 | Active in user mode |
| 1 1 | Active in kernel mode and user mode |

¹¹Kernel partitions are visible in system mode also.

(Partition) Addressing Type (ADR)

| ADR | Partition type |
|---|---|
| 0 | 16-bit addressing mode. This option |
| | makes the MMU ignore the extended |
| | address bits (bits 16 to 18) when |
| | making an address comparison while |
| | select partitions. |
| | In banking mode, this makes the |
| | partition common type (applicable to |
| | both code and data). |
| | In linear addressing expansion, this |
| | makes the partition repeated in all |
| | 64k segments - not very useful. |
| 1 | 19-bit addressing. |
| | Used for linear addressing extension. |
| | In banking mode, this makes the |
| | partition (code or data) banked. |

Access Type

| ACC | Bus type |
|---|---|
| 0 0 0 | Inactive |
| 0 0 1 | Reserved - same as 00000 |
| 0 1 0 | Code - Execute and Read (no restriction) |
| 0 1 1 | Code - Execute only¹² |
| 1 0 0 | Data - Read/Write (no restriction) |
| 1 0 1 | Data - Read only |
| 1 1 0 | Unified - Read/Write/Execute (no restriction) |
| 1 1 1 | Unified - Read/Execute |

¹²MOVC read should be possible from code executed in the same partition. A 3-bit latch (3 DFFs) is used to stored the partition #, from which the last opcode fetch has happened. So if the MOVC target partition is the same as the last opcode fetch partition, MOVC should be allowed. Otherwise, MOVC is disallowed for a partition that is configured as execute only.

All parameters of one memory partition can be encoded in 4 SFRs, they are,

PADR.n

(n=0-7)—n is decided by the content of RSL of MMUCNTRL

Address: C2h

Reset Value: 00h*-See Chapter 5 on defaults for partitions 1 and 2.

Access: System access only

| | | | | | | | |
|---|---|---|---|---|---|---|---|
| — | — | PADR.5 | PADR.4 | PADR.3 | PADR.2 | PADR.1 | PADR.0 |

LADR.n

(n=0-7)—n is decided by the content of RSL of MMUCNTRL

Address: C3

Reset Value: 00h*-See Chapter 5 on defaults for partitions 1 and 2.

Access: System access only

| | | | | | | | |
|---|---|---|---|---|---|---|---|
| LADR.7 | LADR.6 | LADR.5 | LADR.4 | LADR.3 | LADR.2 | LADR.1 | LADR.0 |

PSZ.n

(n=0-7)—n is decided by the content of RSL of MMUCNTRL

Address: C4h

Reset Value: 00h*-See Chapter 5 on defaults for partitions 1 and 2.

Access: System access only

| | | | | | | | |
|---|---|---|---|---|---|---|---|
| — | — | PSZ.5 | PSZ.4 | PSZ.3 | PSZ.2 | PSZ.1 | PSZ.0 |

PARCFG.n

(n=0-7)—n is decided by the content of RSL of MMUCNTRL

Address: C5h

Reset Value: 00h*-See Chapter 5 on defaults for partitions 1 and 2.

Access: System access only

| | | | | | | | |
|---|---|---|---|---|---|---|---|
| ADR | ACC.2 | ACC.1 | ACC.0 | MEM 1 | MEM 0 | PAR.1 | PAR.0 |

There are a total of 8 sets of these registers. Thus a total 32 SFRs are used to configure the MMU partitions. At any given time, only one of the 8 sets of 4 SFRs is mapped to the SFR space, at addresses C2h, C3h, C4h and C5h. A select SFR, PARSL decides which one of the 8 sets of SFRs is selected for read or write access. We call this type of SFR access “rolling window SFR access”.

MMUCNTRL

Address: C1h

Reset value: 00h

Access: System access only

| | | | | | | |
|---|---|---|---|---|---|---|
| BRKMATCH | ENDBG | BYPASSFIXEDPAR | — | RSL.2 | RSL.1 | RSL.0 |

| RSL | Partition registers selected |
|---|---|
| 0 0 0 | Partition 0 register selected |
| 0 0 1 | Partition 1 register selected |
| 0 1 0 | Partition 2 register selected |
| 0 1 1 | Partition 3 register selected |
| 1 0 0 | Partition 4 register selected |
| 1 0 1 | Partition 5 register selected |
| 1 1 0 | Partition 6 register selected |
| 1 1 1 | Partition 7 register selected |

BYPASSFIXEDPAR—When set, will cause MOVC and MOVX to bypass fixed partitions in system mode.

ENDBG—When set, Partition 0 will act as an address comparator for debug/emulation support.

BRKMATCH—Set by hardware when there is a break point match.

MMU configuration registers are System Access only.

SFR address:

| C2h | C3h | C4h | C5h |
|---|---|---|---|
| PADR.0 | LADR.0 | PSZ.0 | PARCFG.0 |
| PADR.1 | LADR.1 | PSZ.1 | PARCFG.1 |
| PADR.2 | LADR.2 | PSZ.2 | PARCFG.2 |
| PADR.3 | LADR.3 | PSZ.3 | PARCFG.3 |
| PADR.4 | LADR.4 | PSZ.4 | PARCFG.4 |
| PADR.5 | LADR.5 | PSZ.5 | PARCFG.5 |
| PADR.6 | LADR.6 | PSZ.6 | PARCFG.6 |
| PADR.7 | LADR.7 | PSZ.7 | PARCFG.7 |

Figure x. “Rolling window access” of MMU SFRs. RSL decides where the window of access is.

MMU to CPU Interface

Referring to FIG. 16, there is shown the details of the interface between the CPU 12 and the MMU 14. When there is one or more memory fault conditions detected, MMU should present 0's to Memory data in. So an illegal read will return 00h, besides triggering an interrupt.

MMU generates a “Memory fault condition” signal internally. (This is different from Memory fault interrupt request). To generate the signal “Memory fault condition”, take the 4 signals that drives “Data Access Fault” and “Code Access Fault” and “Data Out of Bound” and “Code Out of Bound”, OR them together to get Memory fault condition. To pull the data bus to all 0's, AND “Memory fault condition” with memory read strobe to pull memory bus to all 0. Remember to check set up time (a few ns) and hold time (0 or more).

Make sure we are using the signals that drive the MFCON bits, NOT the output from the MFCON bits to generate “Memory fault condition”. Otherwise, the timing requirements would not meet.

To generate Memory fault interrupt request, take the latched memory fault condition bits, including SFR access' violation bits, pass them through their respective mask gates and OR them together to get Memory fault interrupt request. Memory fault interrupt request will be sent directly to the CPU interrupt controller to trigger an interrupt if enabled. There is no need to latch Memory fault interrupt request again since the bits that generated this signal are already latched.

MMU Implementation

As indicated above, CPU should tell MMU, in the form of something decoded from instruction opcode, whether the access is a MOVX read, MOVX write, MOVC, or code fetch for execution.

Based on incoming opcode and 19-bit address, MMU should be able to perform address comparison and determine which partition is visited and whether there is a fault condition. Once MMU has decided which partition to visit, it will then generate the address with the appropriate translation for the memory it intends to access.

If partitions overlap in 80c51's logic memory space, partition 0 takes precedence over partition 1; partition 1 takes precedence over partition 2; and so on. Fixed partitions take precedence over software-configured partitions.

Below are the steps for performing addressing translation
1. offset=cpu address−partition logical address
2. if partition size>offset>0 AND access type (code fetch, MOVC, MOVX r/d, access restrictions) are allowed, then partition will be selected for access.
3. physical address=partition physical address+offset

These operations will be performed in parallel to all partitions that are active in the current mode, include fixed partitions if in kernel mode.

Note: Only 1 partition should be selected for each memory access.

If the conditions in step 2 are not satisfied for any active partition, no memory access should take place. No strobes will be generated. The address and data bus optimally should not even switch to save power. In addition, the MMU should set the memory access fault interrupt flag.

Steps to Select a Partition for Memory Translation

1) Compare operating mode with PAR bits for each partition. Reject ones that are not active.

2) Compare instruction type with ACC(2:1) bits of each partition. Reject ones that are in the wrong space.

3) Check upper and lower bounds of each partition. Disqualify ones that are out of bound. If more than one partition is qualified, use precedence rule to select only one. If none is qualified, generate out of bound fault.

4) Compare instruction type with ACC(0) to see if the access is allowed. If not, generate a CFLT or DFLT condition accordingly.

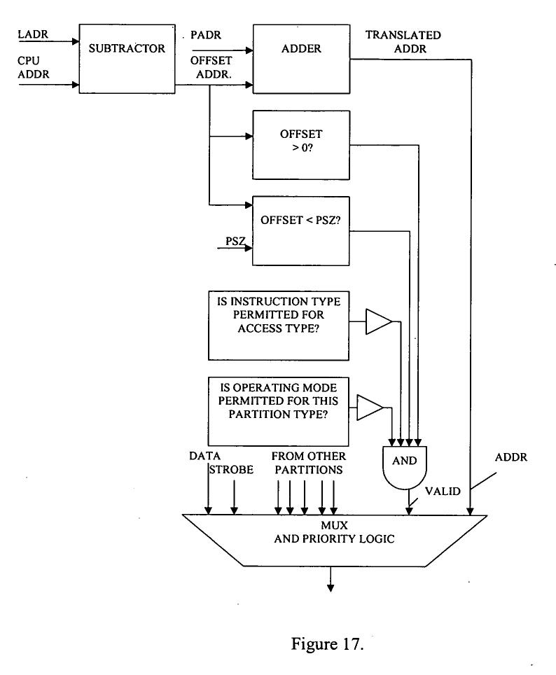

This approach will imply the following. If 2 partitions overlap in logical space and there is an access to that space, using precedence rule, 1 of them will be selected. If the access is consequently rejected due to access violation, that is the end of it. The other partition will never be considered. Referring to FIG. 17 there is shown the details of one embodiment of the MMU 14.

MMU Mode Change

Since CPU mode switching will cause immediate change in the address bus for both code and data fetching, it is important that the timing for CPU mode switching is handled correctly.

On Entering Interrupt from User Mode

When an interrupt request is processed, the following series of event happens
1. Finishing the current instruction cycle, abort write if necessary.
2. SP<=SP+1
3. (SP)<=PC(7:0)
4. SP<=SP+1
5. (SP)<=PC(15:8)
6. PC<=Interrupt Vector Address (15:0).
7. Fetching from new PC
8. Executing first instruction in the interrupt handler (decoding, reading operands, ALU, write back).

In this list, steps 2 to 6 are part of the interrupt instruction, although fetching the next instruction might occur before the next instruction cycle begins in a pipelined implementation that does prefetch.

To avoid putting out a bogus address, the M mode bit and CPU mode should change after step 1 and before step 7 (preferably before step 6). During this period of time no code and data access should take place.

On Exiting Interrupt Into User Mode

When executing RETI, the following series of event happens.
1. Fetching the RETI instruction
2. PC(15:8)<=(SP)
3. SP<=SP−1
4. PC(7:0)<=(SP)
5. SP<=SP−1
6. Fetching the next instruction.

In this list, steps 2 to 5 are part of the RETI instruction, although fetching the next instruction might occur before the next instruction cycle begins in a pipelined implementation that does prefetch.

To avoid putting out a bogus address, the M mode bit and CPU mode should change after step 1 and before step 6. During this period of time no code and data access should take place.

It is for this reason that we require the developer rely on interrupt and RETI only as the method of changing operating modes.

Fault interrupt should abort write in the current instruction and perform long jump in the next instruction cycle.

Additional Properties of Partition 0

The Partition 0 has some additional properties defined by the MMUCNTRL SFR

MMUNCTRL

Address: C1

Reset value: 00h

Access: System access only

| | | | | | | |
|---|---|---|---|---|---|---|
| BRKMATCH | ENDBG | BYPASSFIXEDPAR | — | RSL.2 | RSL.1 | RSL.0 |

BYPASSFIXEDPAR—When set, will cause MOVC and MOVX to bypass fixed partitions in system mode. So the firmware can freely access the memory in mapped for the kernel mode.

ENDBG—When set, Partition 0 will act as an address comparator for debug/emulation support.

BRKMATCH—Set by hardware when there is a break point match.

RSL—Select pointer for the MMUCFG SFRs.

Debug/Emulation Support

When the debug/emulation option is selected by setting ENDBG, partition 0 will change behavior to the following.

The address from CPU will be compared with a break point address stored in the MMUCFG registers. When there is a match, the MMU will automatically set the system interrupt by setting the BRKMATCH bit in MMUCNTRL (System interrupt is caused by Or'ing SSINT flag and the BRKMATCH flag). This will make partition 0 act as an embedded in-circuit emulator (Embedded ICE).

The break point address is encoded as the following.

PADR.0

Address: C2h

Reset Value: 00h

Access: System access only

| | | | | | | | |
|---|---|---|---|---|---|---|---|
| — | — | BRK.5 | BRK.4 | BRK.3 | BRK.2 | BRK.1 | BRK.0 |

LADR.0

Address: C3h

Reset Value: 00h

Access: System access only

| | | | | | | | |
|---|---|---|---|---|---|---|---|
| BRK.13 | BRK.12 | BRK.11 | BRK.10 | BRK.9 | BRK.8 | BRK.7 | BRK.6 |

PSZ.0

Address: C4

Reset Value: 00h

Access: System access only

| | | | | | | | |
|---|---|---|---|---|---|---|---|
| — | — | RES | BRK.18 | BRK.17 | BRK.16 | BRK.15 | BRK.14 |

PARCFG.0

Address: C6h

Reset Value: 00h

Access: System access only

| | | | | | | | |
|---|---|---|---|---|---|---|---|
| — | — | RES | RES | RES | C/D | MASKH | RES |

BRK.0-BRK.18 makes up the 19-bit break point address.

MASKH—when set, will make the comparator ignore bits BRK.16-BRK.18 for a 16-bit comparison.

C/D—C/D differentiates whether the break point is a code break point or data break point. When C/D is 0, the break point is a code break point. The break point match is qualified by the memory access being a code fetch. When C/D is 1, the break point is a data break point. The break point match is qualified by the memory access is a data fetch or write due to MOVC read or MOVX read/write.

In operation, Every CPU address is compared with BRK.0-BRK.18. If there is a match, MMU will set the BRKMATCH bit in MMUCNTRL, thus cause a system interrupt when enabled.

Virgin Modes—MMU Support of Factory Firmware Installation and Testing

Overview

There is a signal from NVM, SOCIsFactoryVirgin, that tells MMU one additional piece of information: whether the device is in virgin state or not.

If the device is in virgin state, the device memory map will go through a series of changes of states. This chapter will describe these changes.

The SOCIsFactoryVigin is sampled once after reset. At the first rising edge of the clock of the first machine cycle after reset signal goes away.

The NVM cells that generate the SOCIsFactoryVigin signal can be cleared by programming. This action is irreversible.

Virgin 0 State:

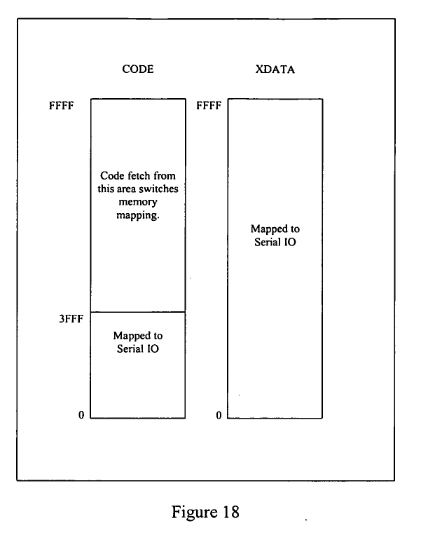

After reset, if the device is in virgin 0 state, the memory map will look like that shown in FIG. 18. Notice that the fixed partitions will be disabled.

Here both program and data memory accesses are redirected to the serial IO port.

Virgin 1 State

After code fetch from address 4000h or above¹³, the device switches to Virgin 1 state, and stays in Virgin 1 state until another reset. Note that ProtectedROM, Hage are mapped to their normal addresses, but of unified type. The SRAM is mapped as unified memory starting at address EO00h.
¹³ The device switch to Virgin 1 state after any of address lines A14 goes from low to high. There is a 3-clock cycle delay to avoid switching in the middle of a machine cycle. When the device is in virgin 1, it will stay in virgin 1 until another reset.

All other address space will be mapped as IO as memory, UNLESS a software-configured MMU partition is created in that region. MMU partitions take precedence over IO as Memory.

So the MMU will have the following behavior change in Virgin 1 state. For a CPU access, if none of the partition is selected, that access will be directed to IO-as-memory, instead of being blocked.

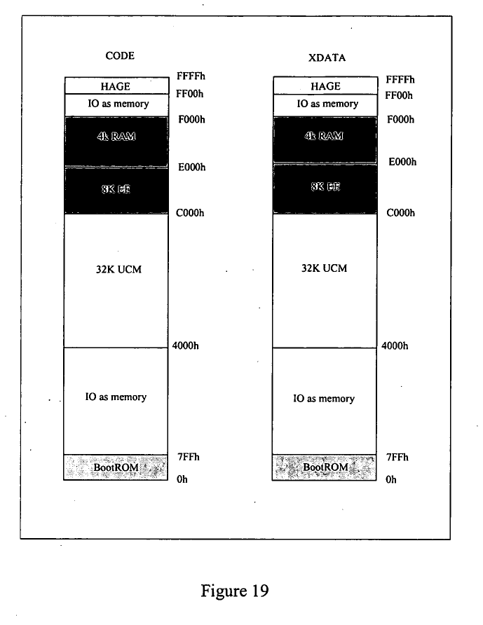

The MMU default settings will map UCM, EEPROM to the addresses shown in FIG. 19, for testing purposes.

MMU partitions that are active in kernel mode are active in system mode also.
Partition 1
Physical address: 0h
Memory type: UCM0
Size: 1 Fh (32 k)
Logical address: 4000h
ACC: 0110 unified, execute/read/write
PAR 01
MEM 00
Partition 2
Physical address: 0h
Memory type: EE
Size: 1 Fh (8 k)
Logical address: C000h
ACC: 0110 unified, execute/read/write
PAR 01
MEM 10
   Properties of Fixed Partitions in Non-Virgin Mode

Boot ROM (00h-7FFh)

System mode only/Non-virgin:

Physical address: 17800h(260), 21800h(170).

Logical address: 0h

Partition size: 800h (2 k) bytes

Physical memory type: UCM.

Partition type: System mode only

(there should be a metal option to make the BootROM size 4 k (1000h) instead.)

Access type: 1) Code 2) Execute, 3) MOVC read allowed. 4) Write not allowed.

512 Bytes Hare (FE00h-FFFFh)

System mode only/Non-virgin:

Physical address: 11000h(260), 9000h (170).

Logical address: FE00h

Partition size: 512 Bytes (200h)

Physical memory type EE

Partition type: System only

Access type: 1) Unified, 2) Execute. 3) MOVC read allowed. 4) MOVX read allowed. 5) MOVX write allowed.

SRAM

System mode only/Non-virgin:

Physical address: 0h

Logical address: 0h

Partition size: 6 k (1800h)—260, 4 k (1000h)—170

Physical memory type SRAM

Partition type: System mode only

Access type: Data, read/write

All fixed partitions are in 16-bit addressing mode. That is only 16 bit addresses are compared to generate partition selections. These partitions are mapped to all 64 k banks from a banking point of view.

Properties of Fixed Partitions in Virgin 1 Mode

ProtectedROM (00h-7FFh)

Physical address: UCM1:17800h (260), 21800h (170)

Logical address: 0h

Partition size: 2 k or 800h bytes

Physical memory type: UCM1 (260), UCM (170)

Partition type: System mode

Access type: Unified, no restriction.

512 Bytes Hage (FE00h-FFFFh)

Physical address: 9000h (170), 11000h(260)

Logical address: FE00h

Partition size: 512 Bytes (200h)

Physical memory type EE

Partition type: System mode

Access type: 1) Unified, No restriction.

SRAM

Physical address: 0h.

Logical address: E000h(260), E000h (170).

Partition size: 6 k (260), 4 k (170)

Physical memory type SRAM

Partition type: System mode

Unified, execute/read/write (i.e. No access restriction.)

All fixed partitions are in 16-bit addressing mode: That is only 16 bit addresses are compared to generate partition selections. These partitions are mapped to all 64 k banks from a banking point of view.

Hardwired Physical Limit Check in UCM1 and EE to Prevent Illegal Access to BootROM and Hage

For ProtectedROM

Under the following conditions:
Physical memory access address is 17800h or bigger.
Memory access is targeted at UCM1
Operating mode is not system mode.

Then
Disallow any memory access, including read and write.
Latch SecurityStatus.6, currently used for “physical memory out of bound”.
   For Hage

Under the following conditions:
Physical memory access address is 11000h or bigger.
Memory access is targeted at EE.
Operating mode is not system mode.

Then
Disallow any memory access, including read and write.
Latch SecurityStatus.6, currently used for “physical memory out of bound”.

We want to disallow illegal access, read, write to BootROM and Hage, unless the CPU is in the system mode and the BootROM or Hage fixed partitions are selected.

The circuit should be implemented as simple and fast as possible so we do not cut down memory access time. Address checking can be performed using the highest nibble of the address only, to minimize gate delay.

As can be seen from the foregoing, an integrated circuit device, such as a smart card, with improved security access is disclosed.

What is claimed is:

1. An integrated circuit device comprising:
a processing unit;
a memory management unit;
a memory;
wherein said memory management unit is interposed between said memory and said processing unit for controlling access to said memory by said processing unit in one of three modes:
a system mode wherein said processing unit can access a system program stored in said memory for controlling resources of said integrated circuit device;
a kernel mode wherein said processing unit can access an operating system program stored in said memory for controlling resources of said integrated circuit device, wherein the resources are limited by said system program; and
a user mode wherein said processing unit can access an application program stored in said memory for controlling resources of said integrated circuit device, wherein the resources are limited by said operating system program.

2. The integrated circuit device of claim 1 further comprising a mode register for storing data representative of said system mode, said kernel mode, and said user mode, wherein said mode register is connected to said processing unit, and to said memory management unit.

3. The integrated circuit device of claim 2 wherein data in said mode register can be altered only by said processing unit executing said system program in said system mode.

4. The integrated circuit device of claim 1 wherein said memory includes a non-volatile memory having a controller for writing and erasing said non-volatile memory.

5. The integrated circuit device of claim 4 wherein said resources of said integrated circuit device includes said controller for writing and erasing said non-volatile memory.

6. The integrated circuit device of claim 4 wherein said resources of said integrated circuit device further comprises a crypto graphic coprocessor for encrypting data from said integrated circuit device.

7. An integrated circuit device comprising
a processing unit;
a memory management unit;
a memory;
wherein said memory management unit is interposed between said memory and said processing unit for controlling access to said memory by said processing unit in one of two modes:
a system mode wherein said processing unit can access a system program from said memory for controlling resources of said integrated circuit device; and
a non-system mode wherein said processing unit can access a non-system program, wherein execution of said non-system program can cause a system interrupt causing program execution to revert to said system mode, but to a specified entry address of the system program, wherein after processing said system interrupt, operation returns to said non-system program in said non-system mode.

8. The integrated circuit device of claim 7, wherein said memory management unit maps the physical memory space of said memory to the logical memory space accessible by said processing unit;
wherein in said system mode, said memory management unit maps the system program to one memory map, and maps the non-system program and its associated data to another map;
wherein in said non-system mode, said memory management unit maps the non-system program and its associated data to one map.

9. The integrated circuit device of claim 7 wherein said non-system program comprises an operating system program and a user program, and wherein said memory management unit further controls access to said memory by said processing unit in said non-system mode in
a kernel mode wherein said processing unit can access the operating system program stored in said memory for controlling resources of said integrated circuit device, wherein the resources are limited by said system program; and
a user mode wherein said processing unit can access the user program stored in said memory for controlling resources of said integrated circuit device, wherein the resources are limited by said operating system program.

10. The integrated circuit device of claim 9 further comprising a mode register for storing data representative of said system mode, said kernel mode and said user mode, wherein said mode register is connected to said processing unit, and to said memory management unit.

11. The integrated circuit device of claim 10 wherein data in said mode register can be altered only by said processing unit executing said system program in said system mode.

12. The integrated circuit device of claim 9 wherein said memory includes a non-volatile memory having a controller for writing and erasing said non-volatile memory.

13. The integrated circuit device of claim 12 wherein said resources of said integrated circuit device includes said controller for writing and erasing said non-volatile memory.

14. The integrated circuit device of claim 9 wherein said resources of said integrated circuit device further comprises a crypto graphic coprocessor for encrypting data from said integrated circuit device.
